(19) United States
(12) Patent Application Publication
(10) Pub. No.: US 2009/0293919 A1
(43) Pub. Date: Dec. 3, 2009

(54) METHOD FOR CLEANING SEMICONDUCTOR WAFER

(75) Inventors: Takeo Katoh, Minato-ku, Tokyo (JP); Kazushige Takaishi, Minato-ku, Tokyo (JP); Ryuichi Tanimoto, Minato-ku, Tokyo (JP)

Correspondence Address: FITZPATRICK CELLA HARPER & SCINTO, 1290 Avenue of the Americas, NEW YORK, NY, 10104-3800, US

(73) Assignee: SUMCO CORPORATION, Minato-ku, Tokyo (JP)

(21) Appl. No.: 12/474,774

(22) Filed: May 29, 2009

(30) Foreign Application Priority Data
Jun. 2, 2008 (JP) 2008-144361

(51) Int. Cl. B08B 3/04

(52) U.S. Cl. 134/33

(57) ABSTRACT

A semiconductor wafer is cleaned by supplying a given cleaning solution to a central position of a front surface and/or a back surface of a semiconductor wafer while rotating the wafer, wherein the cleaning is conducted so as to form a water film having a thickness of 5-10 μm on a whole surface of the wafer with the cleaning solution.

### BACKGROUND OF THE INVENTION

1. Field of the Invention

This invention relates to a method for cleaning a semiconductor wafer, and more particularly to a sheet-feed type method for cleaning a semiconductor wafer wherein the cleaning is conducted by supplying a given cleaning solution to a central position of a front surface and/or a back surface of a semiconductor wafer while rotating the wafer.

2. Description of the Related Art

A step for cleaning a semiconductor wafer is conducted for selectively removing an organic matter, an alkali/heavy metal, native oxide film or particles and the like. A method for cleaning the front and back surfaces of the semiconductor wafer is roughly classified into a wet cleaning and a dry cleaning. The wet cleaning is a cleaning method wherein materials to be treated on the surface of the wafer are removed by supplying water or a cleaning solution, which is usually used since early time. On the other hand, the dry cleaning is a method wherein materials to be treated can be removed as a volatile material by reacting with a reaction seed produced in a vapor phase, which is safe as compared with the wet cleaning operation and excellent in the process controllability, but is difficult to be actually applied because it should be generally conducted within a temperature range of from room temperature to 300° C. and hence a situation capable of using a dry process at a high process temperature is limited.

The wet cleaning can be divided into a batch type and a sheet-feed type. The batch type cleaning is a cleaning method as shown in FIG. 2 wherein a plurality of wafers (typically about 25 wafers) are immersed at a state of fixing to a carrier 200 into a cleaning tank 300 filled with a cleaning solution. This method can clean the plural wafers at once, and is preferable in view of the operation efficiency, but has problems that since the wafers are merely immersed into the cleaning solution, the cleaning uniformity on the surface of the semiconductor wafer is low, and that since an apparatus 100 is large-scale, a greater amount of water used in the cleaning solution is consumed.

On the other hand, as shown in FIG. 3, the sheet-feed type cleaning method is a method for cleaning a semiconductor wafer wherein the cleaning is carried out every one semiconductor wafer 10 by supplying a given cleaning solution from a cleaning nozzle(s) 30 or the like to a central position of a front surface and/or a back surface of the wafer while rotating the wafer 10 with a nozzle 40 for supplying ultrasonic pure water, a disc brush 50 or the like, if necessary. This sheet-feed type cleaning method is high in the cleaning uniformity on the surface of the semiconductor wafer and excellent in a point that a miniaturization of the apparatus is made possible as compared with the batch type cleaning apparatus and hence the increase of the installation area in a clean room can be suppressed, but has a problem that a greater amount of water used in the cleaning solution is consumed likewise the batch type cleaning method.

In recent years, a semiconductor wafer having a diameter of not less than 450 mm has been developed. In case of cleaning such a large-diameter wafer, it is required to use an even larger amount of ultra pure water (which is a pure water having TOC of not more than 10 ppb and resistance of not more than 18 MΩ) in association with the increase of the wafer area, and also recycled water or the like cannot be used, so that it is desired to develop a method capable of reducing the use of the cleaning solution from viewpoints of cost and environment.

### SUMMARY OF THE INVENTION

It is, therefore, an object of the invention to provide a method for cleaning a semiconductor wafer, particularly a large-diameter wafer, which is capable of efficiently cleaning a front surface (and a back surface) of the wafer with an amount of a cleaning solution as small as possible.

The inventers have made various investigations for solving the above problems and found that in a sheet-feed type method for cleaning a semiconductor wafer wherein the cleaning is conducted by rotating the wafer, when cleaning is conducted by supplying a given cleaning solution to a central position of a front surface and/or a back face of a semiconductor wafer while rotating the wafer, the cleaning is controlled so as to uniformly and thinly form a water film having a thickness of 5-10 μm, which was not less than 20 μm in the conventional technique, on a whole surface of the wafer with the cleaning solution, and hence the effective cleaning is made possible by the water film uniformly formed on the wafer but also the amount of the cleaning solution used can be suppressed to a minimum because the thickness of the water film becomes as thin as 10 μm.

The summary and construction of the invention for achieving the above object are as follows.

(1) A method for cleaning a semiconductor wafer through a sheet-feed type system by supplying a given cleaning solution to a central position of a front surface and/or a back face of a semiconductor wafer while rotating the wafer, wherein the cleaning is controlled so as to form a water film having a thickness of 5-10 μm on a whole surface of the wafer with the cleaning solution.

(2) A method for cleaning a semiconductor wafer according to the item (1), wherein the thickness of the water film is controlled by a revolution speed of the wafer, an amount of the cleaning solution supplied and/or a viscosity of the cleaning solution.

(3) A method for cleaning a semiconductor wafer according to the item (2), wherein the revolution speed of the wafer is within a range of 600-6000 rpm.

(4) A method for cleaning a semiconductor wafer according the item (2), wherein the amount of the cleaning solution supplied is within a range of 0.5-5 L/min.

(5) A method for cleaning a semiconductor wafer according to the item (2), wherein the viscosity of the cleaning solution is within a range of 0.1-1.5 cps.

(6) A method for cleaning a semiconductor wafer according to the item (1), wherein the semiconductor wafer has a diameter of not less than 450 mm.

(7) A method for cleaning a semiconductor wafer according to the item (1), wherein the amount of the cleaning solution required for cleaning the semiconductor wafer is reduced to not less than 60% of an amount in a conventional sheet-feed type method for cleaning a wafer.

According to the invention, it is possible to provide a method for cleaning a semiconductor wafer, which is capable of efficiently cleaning a front surface (and a back surface) of a wafer, particularly a large-diameter wafer with an amount of a cleaning solution as small as possible.

### BRIEF DESCRIPTION OF THE DRAWINGS

The invention will be described with reference to the accompanying drawings, wherein:

FIG. 1 is a side view in section showing states of a wafer and a water film for explaining a cleaning method according to the invention;

FIG. 2 is a schematically cross-sectional view of the conventional batch type cleaning apparatus;

FIG. 3 is a perspective view of a sheet-feed type cleaning apparatus;

FIG. 4 is a graph showing a relationship between a thickness of a water film made of a cleaning solution (μm) and LPD number; and

FIG. 5 is a graph showing a relationship between an amount of a cleaning solution supplied (L/min) and a thickness of a water film (μm).

### DESCRIPTION OF THE PREFERRED EMBODIMENTS

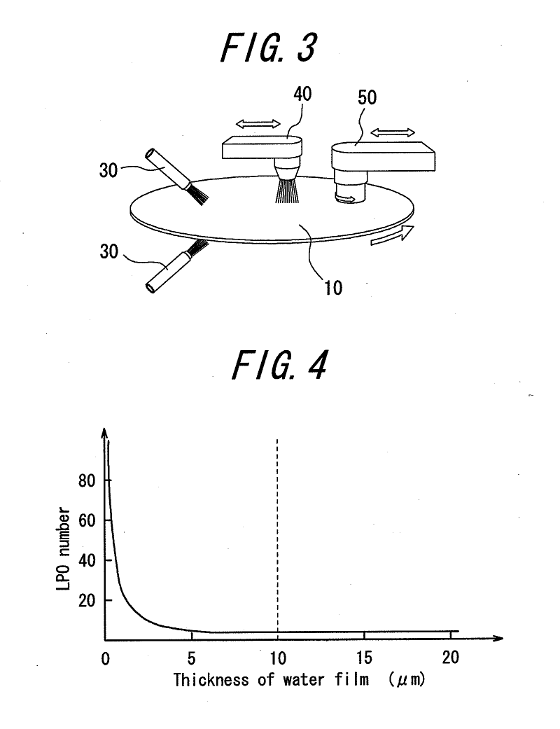

As shown in FIG. 3, the method for cleaning a semiconductor wafer according to the invention is a sheet-feed type method for cleaning a semiconductor wafer wherein the cleaning is conducted by supplying a given cleaning solution 30 to a central position of a front surface and/or a back surface of a semiconductor wafer 10 while rotating the wafer 10. Details on each construction will be described below.

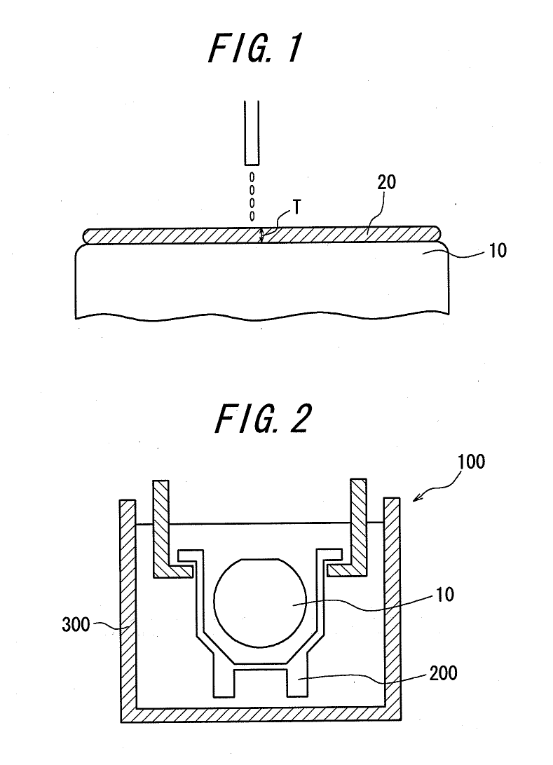

The cleaning method of the invention is characterized by controlling the cleaning so as to form a water film 20 of the cleaning solution having a thickness T of not more than 10 μm on a whole surface of the wafer 10 as shown in FIG. 1. Since the water film 20 of the cleaning solution is uniformly formed on the whole surface of the wafer 10, it is possible to conduct the effective cleaning having a high cleaning uniformity, but also the amount of the cleaning solution used can be largely suppressed as compared with the conventional sheet-feed type cleaning since the thickness of the water film 20 is as thin as 10 μm, so that the cleaning of the invention is an effective means. In order to uniformly form the water film 20, it is preferable to constantly control the revolution speed of the wafer and the amount of the cleaning solution supplied in the sheet-feed type cleaning.

The reason why the thickness T of the water film 20 is limited to not more than 10 μm is due to the fact that when the thickness of the water film exceeds 10 μm, there is no problem in the cleaning effect, but the effect of reducing the amount of the cleaning solution used according to the invention is not obtained though it depends on the size of the wafer 10. While, when it is less than 1 μm, the sufficient cleaning capability can not be obtained. Therefore, the thickness is required to be 1 to 10 μm, and it is more preferable to be a range of 5-10 μm in view of ensuring the high cleaning capability.

Now, FIG. 4 is a graph showing a relationship between a thickness (μm) of a water film formed on the whole surface of the wafer and LPD number after cleaning when a semiconductor wafer having the LPD number of not less than 1000 is cleaned with a cleaning solution of ozone water and hydrofluoric acid. As seen from FIG. 4, even when the thickness of the water film becomes not less than 10 μm, there is substantially no difference in the cleaning effect, so that it is preferable to be not more than 10 μm for reducing the amount of water used and avoiding the wasteful use of the cleaning solution.

Moreover, the thickness T of the water film 20 is preferable to be controlled by a revolution speed of the wafer 10, an amount of the cleaning solution supplied and/or a viscosity of the cleaning solution. Since the above three parameters are factors most acting on the thickness of the water film 20, if the control of the thickness T is conducted by the other parameter, it is feared that the control becomes difficult.

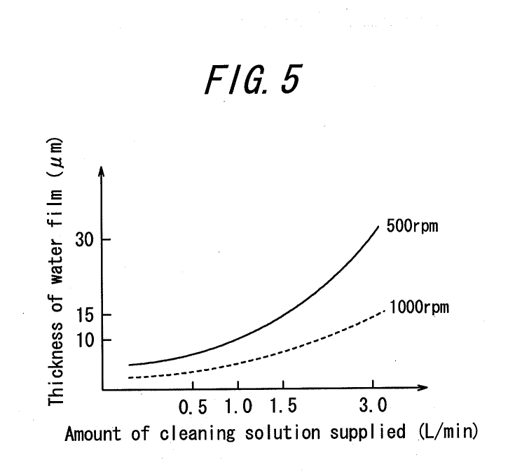

FIG. 5 is a graph showing a relationship between an amount of the cleaning solution supplied and a thickness T of the water film 20 in terms of two different revolution speeds (500 rpm, 1000 rpm) of the wafer. As shown in FIG. 5, the thickness T of the water film 20 varies highly depending on the amount of the cleaning solution supplied and further changes largely in accordance with the revolution speed of the wafer, so that these parameters are effective to the control of the thickness T.

The revolution speed of the wafer 10 is preferable to be a range of 600 to 6000 rpm. When the revolution speed is less than 600 rpm, the water film 20 can not be formed uniformly on the whole surface of the wafer and it is difficult to obtain an expected cleaning effect, while when it exceeds 6000 rpm, it is difficult to constantly control the thickness T of the water film 20.

The amount of the cleaning solution supplied is preferable to be a range of 0.5 to 5 L/min. When the amount is less than 0.5 L/min, the water film 20 can not be formed uniformly on the whole surface of the wafer and it is difficult to obtain an expected cleaning effect, while when it exceeds 5 L/min, it is difficult to control the thickness T of the water film 20 to not more than 10 μm.

Furthermore, the viscosity of the cleaning solution is preferable to be a range of 0.1 to 1.5 cps. When the viscosity is less than 0.1 cps, the water film 20 can not be formed uniformly on the whole surface of the wafer and it is difficult to obtain an expected cleaning effect, while when it exceeds 1.5 cps, it is difficult to control the thickness T of the water film 20 to not more than 10 μm.

A material of the cleaning solution is not particularly limited as long as it can control the thickness T of the water film 20 to not more than 10 μm, and a commonly used cleaning solution (e.g. ammonia water, aqueous solution of an organic acid, function water or the like) may be used.

In the cleaning method according to the invention, the cleaning is conducted by the rotation of the wafer 10. However, as shown in FIG. 3, a nozzle 40 with ultrasonic wave or the like may also be used, if necessary. Even in the latter case, the effect according to the invention can be developed similarly when the thickness T of the water film 20 is not more than 10 μm.

The semiconductor wafer used in the invention is preferable to be a semiconductor wafer having a diameter of not less than 450 mm. In such a large-diameter wafer, the effect of reducing the amount of the cleaning solution used according to the invention can be remarkably developed though a greater amount of the cleaning solution is used when the conventional cleaning method is applied.

When using the cleaning method according to the invention, the amount of the cleaning solution required for cleaning the semiconductor wafer 10 can be reduced to not less than 40% as compared with the amount used in the conventional sheet-feed type cleaning method. Thus, it can be seen that the invention develops a very excellent effect in terms of cost and environment.

Although the above is described with respect to only one embodiment of the invention, various modifications may be made without departing from the scope of the appended claims.

### EXAMPLE 1

A surface of a semiconductor wafer having a diameter of 450 mm and a crystal orientation of (100) is cleaned by by supplying an aqueous cleaning solution containing ozone, hydrofluoric acid and citric acid (viscosity: 0.9 cps and amount supplied: 2 L/min) to the surface of the wafer while rotating the wafer (revolution speed: 2000 rpm). As a state of a water film made from the cleaning solution is confirmed during the cleaning, the thickness of the water film is 10 μm.

### EXAMPLE 2

The cleaning of the semiconductor wafer is conducted in the same manner as in Example 1 except that the amount of the cleaning solution supplied to the wafer is 1 L/min. As a state of a water film made from the cleaning solution is confirmed during the cleaning, the thickness of the water film is 5 μm.

### COMPARATIVE EXAMPLE 1

The cleaning of the semiconductor wafer is conducted in the same manner as in Example 1 except that the revolution speed of the wafer is 500 rpm. As a state of a water film made from the cleaning solution is confirmed during the cleaning, the thickness of the water film is 15 μm.

### COMPARATIVE EXAMPLE 2

The cleaning of the semiconductor wafer is conducted in the same manner as in Example 1 except that the viscosity of the aqueous cleaning solution containing ozone, hydrofluoric acid and citric acid is 2 cps. As a state of a water film made from the cleaning solution is confirmed during the cleaning, the thickness of the water film is 20 μm.

Evaluation Method

With respect to each sample produced as mentioned above are evaluated (1) the cleaning capability and (2) the amount of ultra pure water used in the cleaning solution.

(1) As to the cleaning capability, the LPD number (bright points) on the wafer after the cleaning is measured with a laser particle counter and evaluated according to the following standard:

⊚: not more than 10

◯: more than 10 but not more than 100

χ: more than 100

(2) The amount of ultra pure water used in the cleaning solution is evaluated by calculating an amount of ultra pure water used in each example (%) relative to a case that the amount of ultra pure water used in Comparative Example 2 is 100% when the thickness of the water film is 20 μm.

TABLE 1

| | | Amount of | | | | |
|---|---|---|---|---|---|---|
| | Revolution | cleaning | Viscosity of | | | |
| | speed of | solution | cleaning | Thickness of | | Amount of ultra |
| | wafer | supplied | solution | water film | Cleaning | pure water used (%) |
| | (rpm) | (L/min) | (cps) | (μm) | capability | (relative to Comparative Example 2) |
| Example 1 | 2000 | 2 | 0.9 | 10 | ⊚ | 50% |
| Example 2 | 2000 | 1 | 0.9 | 5 | ◯ | 40% |
| Comparative | 500 | 2 | 0.9 | 15 | ⊚ | 120% |
| Example 1 | | | | | | |
| Comparative | 2000 | 2 | 2 | 20 | ⊚ | 100% |
| Example 2 | | | | | | |

As seen from Table 1, in Examples 1 and 2, the amount of ultra pure water used is suppressed to a low level while keeping the good cleaning capability because the thickness of the water film is made to not more than 10 μm by controlling the revolution speed of the wafer, the amount of the cleaning solution supplied and the viscosity of the cleaning solution. On the other hand, in Comparative Examples 1 and 2, a greater amount of the cleaning solution is used, so that the amount of ultra pure water used becomes larger though the cleaning capability is high. Also, it is understood that the thickness of the water film can be controlled by varying each parameter of the revolution speed of the wafer, the amount of the cleaning solution supplied and/or the viscosity of the cleaning solution.

According to the invention, it is possible to provide a method for cleaning a semiconductor wafer, which is capable of efficiently cleaning a front surface (and a back surface) of a wafer, particularly a large-diameter wafer with an amount of a cleaning solution as small as possible.

What is claimed is:

1. A method for cleaning a semiconductor wafer through a sheet-feed type system by supplying a given cleaning solution to a central position of a front surface and/or a back surface of a semiconductor wafer while rotating the wafer, wherein said cleaning is conducted so as to form a water film having a thickness of 5-10 μm on a whole surface of the wafer with the cleaning solution.

2. A method for cleaning a semiconductor wafer according to claim 1, wherein the thickness of the water film is controlled by a revolution speed of the wafer, an amount of the cleaning solution supplied and/or a viscosity of the cleaning solution.

3. A method for cleaning a semiconductor wafer according to claim 2, wherein the revolution speed of the wafer is within a range of 600 to 6000 rpm.

4. A method for cleaning a semiconductor wafer according to claim 2, wherein the amount of the cleaning solution supplied is within a range of 0.5 to 5 L/min.

5. A method for cleaning a semiconductor wafer according to claim 2, wherein the viscosity of the cleaning solution is within a range of 0.1 to 1.5 cps.

6. A method for cleaning a semiconductor wafer according to claim 1, wherein the semiconductor wafer has a diameter of not less than 450 mm.

7. A method for cleaning a semiconductor wafer according to claim 1, wherein the amount of the cleaning solution required for cleaning the semiconductor wafer is reduced to not less than 60% of an amount in a conventional sheet-feed type method for cleaning a wafer.
